(19) United States
(12) Patent Application Publication
(10) Pub. No.: US 2009/0196052 A1
(43) Pub. Date: Aug. 6, 2009

(54) FOLDABLE DECORATION STRUCTURE FOR LAMP ASSEMBLY

(76) Inventor: Michele J. Fremont, Providence, RI (US)

Correspondence Address: PERRY HOFFMAN & ASSOCIATES P.C., PO BOX 1649, DEERFIELD, IL, 60015, US

(21) Appl. No.: 12/363,345

(22) Filed: Jan. 30, 2009

Related U.S. Application Data
(60) Provisional application No. 61/025,629, filed on Feb. 1, 2008.

(51) Int. Cl. F21V 1/06

(52) U.S. Cl. 362/352

(57) ABSTRACT

A method and apparatus for a foldable decorative structure for an object or lamp with top and bottom cones defines a container or an interior region assembly. The foldable material used includes a top panel and a bottom panel which may be separate from or integral with the top panel. Concentric semicircular scored fold lines in the foldable material are cut about vertex references and extend from one edge to another edge of the panels. A top cone is defined between the top panel vertex reference and the top panel semicircular scored fold line with the first edge abutting the second edge of the top panel, and a bottom cone is defined between the bottom panel vertex reference and the bottom panel semicircular scored fold line. An interior region between the top cone and the bottom cone can receive the lamp. The first edge abutting the second edge of the top panel and the first edge abutting the second edge of the bottom panel closes the structure of the top panel and the opposing bottom panel to surround the lamp. A number of gusset design elements disposed on the foldable material may be provided at the periphery of the top and bottom panels for structural locking further supporting the shape, strength and integrity of the decorative structure.

### CROSS-REFERENCE TO RELATED APPLICATION

This application claims priority pursuant to 35 U.S.C. 119(e) to U.S. Provisional Application No. 61/025,629, filed on Feb. 1, 2008 which is incorporated herein by reference in its entirety.

### BACKGROUND OF THE INVENTION

1. Field of the Invention

This invention relates generally to light shades or fixtures manufactured from essentially flexible, flat foldable materials, and more particularly to lighting structure assembly methods and apparatus.

2. Description of the Related Art

Various illuminated ornaments are generally known which are adapted to be adorned and considered beautiful bright luminaries or foldable decorations made in various types of geometric configurations. The formation of structural support elements formed into three-dimensional shapes from a plurality of separate individual panels are known in prior art. U.S. Pat. No. 3,668,796 to Patterson, entitled “Combination Greeting Card and Three-Dimensional Ornament” discloses a greeting card that folds flat for mailing and can be folded into a three-dimensional ornament for decorative purposes. The blank from which the ornament is made is generally rectangular, with the resulting article comprising a polyhedron made up of many flat sides and straight edge corners. U.S. Pat. No. 3,799,425 to Fanter, entitled “Blank for Making Containers and Container with Top Formed by Curved Surfaces” discloses a container which can be formed from a single paperboard blank divided by fold lines using a combination of single curved surfaces terminating in sharp edges and corners which result in a box-like container having a dome-shaped top. The top is held together by fastening together tabs which fall in the center of the top. U.S. Pat. No. 4,492,723 to Chadwick, II, entitled “Curvilinear Polyhedral Construction Kit” discloses a construction kit in which flat blanks may be folded into three-dimensional solid objects in which all surfaces are arcuate and clusters of polyhedrons, employing methods and structures disclosed without regard to ease of folding and assembly. U.S. Pat. No. 4,712,725 to Moore, entitled “Container with Integral Fold-In Closure Lid” discloses a container for dispensing foods and for storing articles which includes its own integrally-formed closure lid. The sides of the tapered cylindrical container are folded inward at the top along triangular fold lines which meet at the center to form a lid. The fold pattern provides a concave top surface which facilitates a locking action to better retain articles inside the container. U.S. Pat. No. 5,309,333 to Kandampully, entitled “Light emitting foldable decoration” discloses an extendable adornment in which a light emitting foldable decoration is provided in the form of a three dimensional geometric shaped star with a plurality of radiating points, each of which define hollow compartments, combined centrally to form a hollow central compartment that can be collapsed into a closed position and stored when not in use. U.S. Pat. No. 5,393,579 to Witte, entitled “Dome-like folded structure” discloses three-dimensional structures made by folding flat sheet materials to form an article used as a general purpose support structure, including the formation of a somewhat spherical hanging ornament formed by folding paper construction material, providing a dome shape for external vertical structural integrity which is sphere-like with integrally-formed structural ribs.

### SUMMARY OF THE INVENTION

In accordance with the present inventions, advantageous methods and apparatus are provided for foldable decorative structures for an object or lamp. As discussed in the described embodiments, the decorative structure shape is held and locked through manipulation of support features which create dimension, structural integrity, and define perimeter and closure elements that maintain its exterior shape. Curved and flat scores are manipulated, and may be locked further with gussets for added structural integrity and decorative features. Together the scores and gussets create shapes which can then be tied or fastened around a lamp cord, base, string, or used without any hanging or stationary support.

The foldable decorative structure can be used with structural integrity provided solely by the scoring and closure. The gussets provide alternative structure and design elements. A plurality of cut shaped design elements may be disposed on top and bottom panels to create decorative light patterns and allow for the dissipation of heat, where the plurality of cut shaped design elements provide one or more cuts, perforations, petals, or scored elements in the foldable material. The decorative structure can be manufactured using a range of materials, paper, plastic, card, or fabric etc., and can be printed, silk-screened, beaded, embroidered, or otherwise decorated.

Briefly summarized, the inventions relate to methods and apparatus for a foldable decorative structure for an object or lamp with top and bottom cones defining a container or an interior region assembly. The foldable material used includes a top panel and a bottom panel which may be separate from or integral with the top panel. Continuous shape defining or scored fold lines in the foldable material may be cut about vertex references and extend from one edge to another edge of the panels. A top cone is defined between the top panel vertex reference and the top panel semicircular scored fold line with the first edge abutting the second edge of the top panel, and a bottom cone is defined between the bottom panel vertex reference and the bottom panel semicircular scored fold line. An interior region between the top cone and the bottom cone can receive the lamp. The first edge abutting the second edge of the top panel and the first edge abutting the second edge of the bottom panel closes the structure of the top panel and the opposing bottom panel to surround the lamp. A number of gusset design elements disposed on the foldable material may be provided at the periphery of the top and bottom panels for structural locking further supporting the shape, strength and integrity of the decorative structure.

### BRIEF DESCRIPTION OF THE DRAWINGS

For the purpose of facilitating an understanding of the inventions, the accompanying drawings and description illustrate a preferred embodiment thereof, from which the inventions, structure, construction and operation, and many related advantages may be readily understood and appreciated.

FIGS. 1A & 1B are line drawings illustrating a first embodiment of a foldable decorative structure assembly in accordance with the inventions;

FIGS. 2A & 2B are line drawings illustrating a second embodiment of a foldable decorative structure thereof;

FIGS. 3A & 3B are line drawings illustrating a third embodiment of a foldable decorative structure thereof;

FIGS. 4A & 4B are line drawings illustrating a fourth embodiment of a foldable decorative structure thereof;

FIGS. 5A & 5B are line drawings illustrating a fifth embodiment of a foldable decorative structure thereof in which the semicircular scored fold line in the top panel is offset and the continuous shape defining line is neither concentric nor circular;

FIGS. 6A & 6B are line drawings illustrating a sixth embodiment of a foldable decorative structure thereof;

FIGS. 7A & 7B are line drawings illustrating a seventh embodiment of a foldable decorative structure thereof;

FIGS. 8A, 8B and 8C are line drawings illustrating embodiment views as a top plan view and respective cross-sectional views of the seventh embodiment of FIGS. 7A and 7B;

FIG. 9 is a line drawing illustrating a side view of the seventh embodiment of FIG. 7B;

FIGS. 10A & 10B are line drawings illustrating further side views of the seventh embodiment of FIG. 7B;

FIGS. 11 and 12 provide views illustrating the assembly of the sixth embodiment of FIGS. 6A and 6B;

FIGS. 13A, 13B, 13C and 13D are line drawings illustrating cross-sectional embodiment views and respective side views of the sixth embodiment of FIGS. 6A and 6B; and

FIGS. 14 and 15 provide further views illustrating the assembly of the sixth embodiment of FIGS. 6A and 6B.

### DETAILED DESCRIPTION OF THE EMBODIMENTS

The following description is provided to enable those skilled in the art to make and use the described embodiments set forth in the best modes contemplated for carrying out the invention. Various modifications, however, will remain readily apparent to those skilled in the art. Any and all such modifications, equivalents, and alternatives are intended to fall within the spirit and scope of the present invention. This item as described in an embodiment provides a paper light, or paper shade, herein referred to by Applicant's coined name or “Bright Gazers,” for assembly as a hanging light fixture, free-hanging lamp cord, or standing lamp base. This item emulates other light shades in the marketplace, most notably the “star lights” i.e. U.S. Pat. No. 5,309,333 to Kandampully, entitled “Light emitting foldable decoration” discussed above which has been in the marketplace for many years.

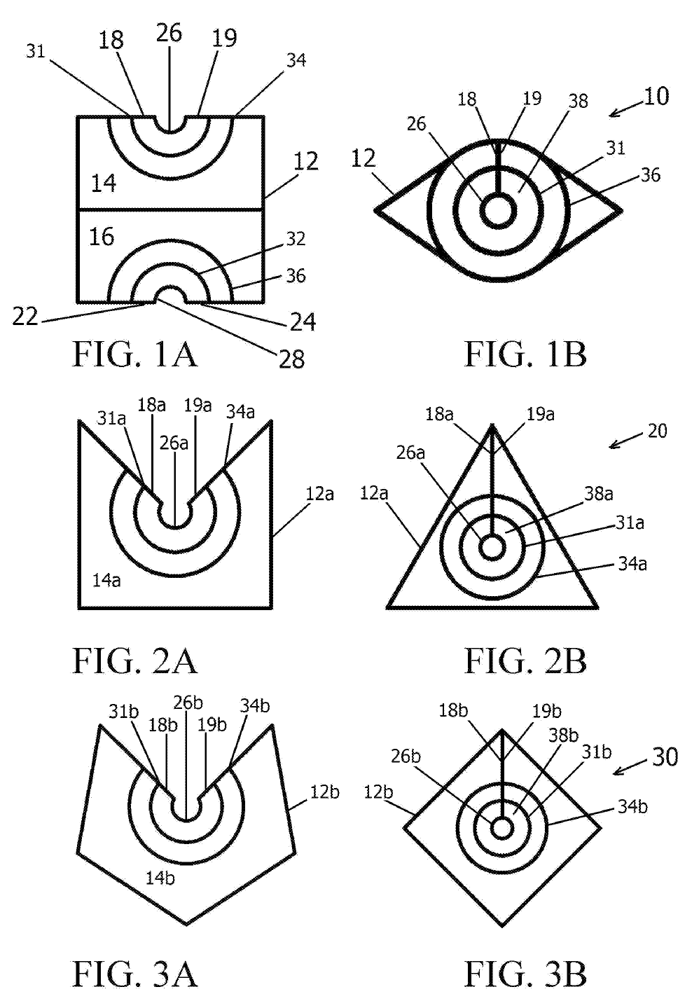

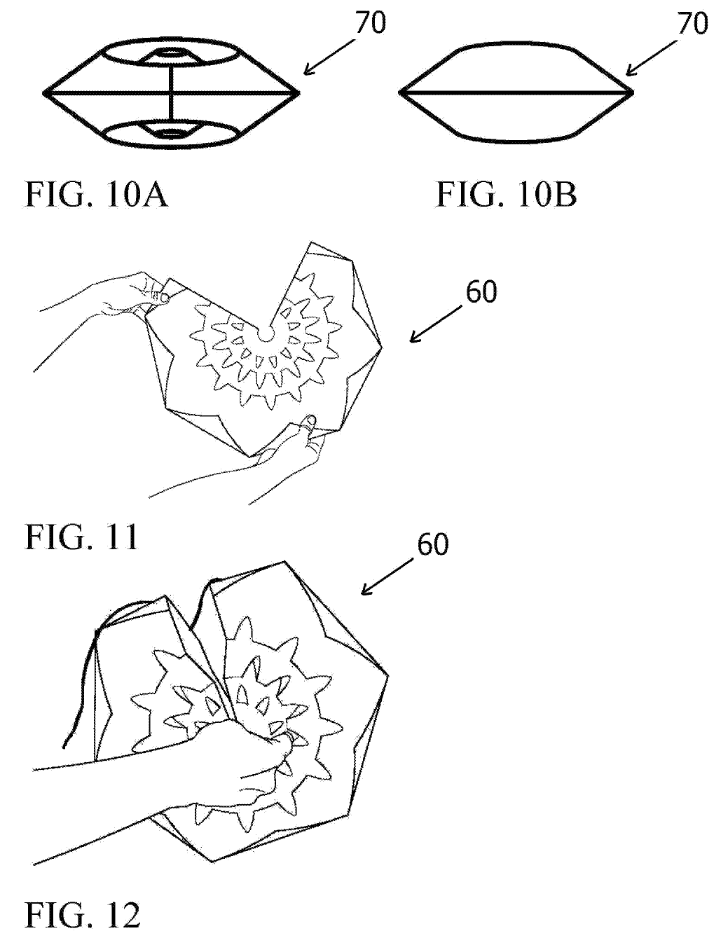

Referring now to the figures, and particularly to FIGS. 1A & 1B, 6A & 6B, 11 and 12 each of which illustrate some of the embodiments described below, in accordance with the inventions, showing foldable decorative structures for an object or lamp. Respective decorative structure embodiments are identified by reference numerals 10, 20, 30, 40, 50, 60, and 70 however it will be appreciated that changes and modifications may be made without departing from the inventions in the various aspects. Foldable material 12 includes a top panel 14 having a first edge 18 and a second edge 19 of the top panel, and an opposing bottom panel 16 having a first edge 22 and a second edge 24 of the bottom panel. A top panel semicircular opening or vertex reference 26 is defined between the first edge 18 and the second edge 19 of the top panel 14, and a bottom panel semicircular opening or vertex reference 28 is defined between the first edge 22 and the second edge 24 of the bottom panel 16, which may be provided and intended as including various opening configurations, various shapes, large, small or absent without limitation, and indeed an opening need not be used at the vertex references. A first top panel semicircular scored fold line 31 is scored into the top panel 14 of the foldable material 12 about the top panel vertex reference 26 and extending from the first edge 18 to the second edge 19 of the top panel 14. A first bottom panel semicircular scored fold line 32 is scored into the bottom panel 16 of the foldable material about the bottom panel vertex reference 28 and extending from the first edge 22 to the second edge 24 of the bottom panel 16, with the first bottom panel semicircular scored fold line 32 positioned to oppose said first top panel semicircular scored fold line 31 in the top panel 14 of the foldable material 12. A second top panel semicircular scored fold line 34, or a second top panel continuous shape defining line including scores and/or opening cuts (see, e.g., FIG. 11) in the top panel 14 may be provided either about or concentric with said first top panel semicircular scored fold line 31 extends from the first edge 18 to the second edge 19 of the top panel 14. A second bottom panel semicircular scored fold line 36 or second bottom panel continuous shape defining line in the bottom panel 16 is provided generally about said first bottom panel semicircular scored fold line 32 extends from the first edge 22 to the second edge 24 of the bottom panel 16. The second bottom panel continuous shape defining line 36 positioned to oppose said second top panel semicircular scored fold line 34 in the top panel 14 of the foldable material 12. When folded into its closed position (FIG. 1B) a top cone 38 is defined between the top panel vertex reference 26 and the first top panel semicircular scored fold line 31 with the first edge 18 abutting the second edge 19 of the top panel 14, e.g., with affixed tabs or other means for connecting the abutting edges together. Also a bottom cone (e.g., see FIG. 10A) is defined between the bottom panel vertex reference 28 and the first bottom panel semicircular scored fold line 32 with the first edge 22 abutting the second edge 24 of the bottom panel 16.

With reference to FIGS. 2A & 2B, 3A & 3B, 4A & 4B, 5A & 5B, and 6A & 6B each of which illustrate some of the described embodiments, the respective decorative structure embodiments as identified by reference numerals 10, 20, 30, 40, 50, 60, 70, FIGS. 2A & 2B illustrate foldable material 12a includes a top panel 14a having a first edge 18a and a second edge 19a of the top panel. A top panel vertex reference 26a is defined between the first edge 18a and the second edge 19a of the top panel 14a. A first top panel semicircular scored fold line 31a is scored into the top panel 14a of the foldable material 12a about the top panel vertex reference 26a and extending from the first edge 18a to the second edge 19a of the top panel 14a. A second top panel semicircular scored fold line 34a in the top panel 14a about said first top panel semicircular scored fold line 31a extends from the first edge 18a to the second edge 19a of the top panel 14a. When folded into its closed position (FIG. 2B) a top cone 38a is defined between the top panel vertex reference 26a and the first top panel semicircular scored fold line 31a with the first edge 18a abutting the second edge 19a of the top panel 14a. Also a panel and bottom cone (e.g., see FIG. 10A) are defined as described herein. As described the foldable material includes a first end and a second end with the first end having the top panel and the second end having the bottom panel provided as foldable to oppose the top panel, with the bottom panel vertex reference positioned to oppose said top panel vertex reference in the top panel thereof. The foldable material may include the top panel and the bottom panel integral with the top panel of the foldable material. Also, the foldable material of the decorative structure having the first foldable material portion and the second foldable material portion, can provide the first foldable material portion having the top panel and the second foldable material portion provided with the bottom panel separate from said top panel which can be affixed together, e.g., with affixed tabs or other means for connecting the top and bottom panels together.

As illustrated, the first edge of the top panel and the second edge of the top panel are disposed on the foldable material with the first edge of the top panel facing and the second edge of the top panel at an angle relative to said first edge and said second edge of the top panel, and wherein the first edge of the bottom panel and the second edge of the bottom panel are disposed on the foldable material with the first edge of the bottom panel facing and the second edge of the bottom panel at an angle relative to said first edge and said second edge of the bottom panel. The first edge of the top panel and the second edge of the top panel may be disposed on the foldable material with the first edge of the top panel facing and the second edge of the top panel at substantially a 90 degree angle or more to pronounce the conical shape, and wherein the first edge of the bottom panel and the second edge of the bottom panel are disposed on the foldable material with the first edge of the bottom panel facing and the second edge of the bottom panel at substantially a 90 degree angle.

Referring to FIGS. 3A & 3B of the respective decorative structure embodiment as identified by reference numeral 30, foldable material 12b is illustrated to include a top panel 14b having a first edge 18b and a second edge 19b of the top panel. A top panel vertex reference 26b is defined between the first edge 18b and the second edge 19b of the top panel 14b. A first top panel semicircular scored fold line 31b is scored into the top panel 14b of the foldable material 12b about the top panel vertex reference 26b and extending from the first edge 18b to the second edge 19b of the top panel 14b. A second top panel semicircular scored fold line 34b in the top panel 14b about said first top panel semicircular scored fold line 31b extends from the first edge 18b to the second edge 19b of the top panel 14b. When folded into its closed position (FIG. 3B) a top cone 38b is defined between the top panel vertex reference 26b and the first top panel semicircular scored fold line 31b with the first edge 18b abutting the second edge 19b of the top panel 14b.

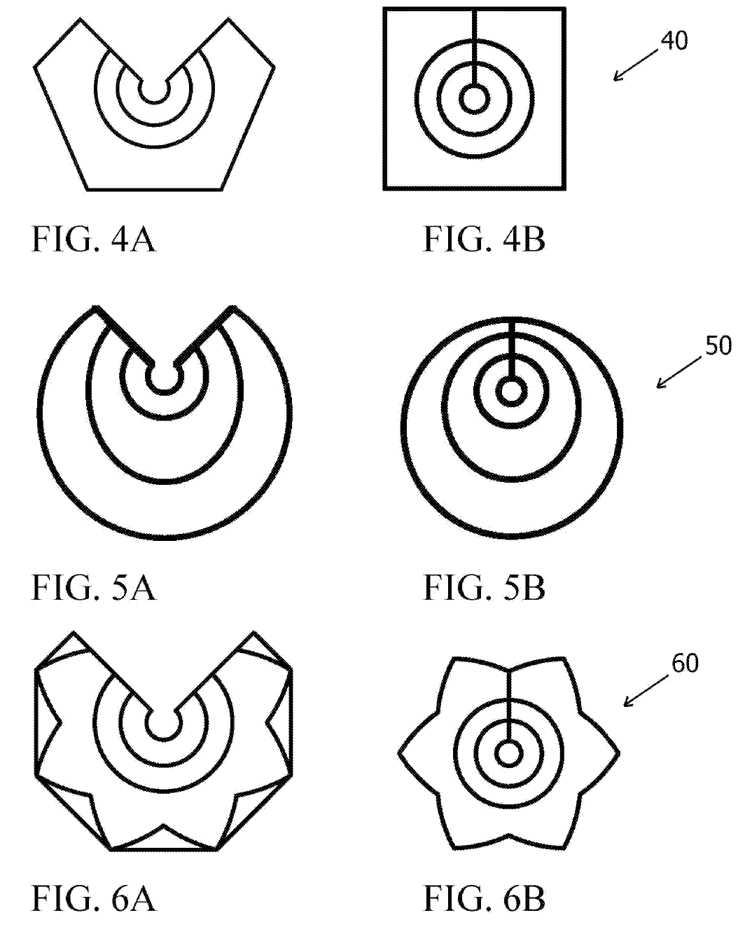

Referring now to FIGS. 4A & 4B, 5A & 5B, 6A & 6B and 7A & 7B each respective decorative structure embodiment as identified also includes the described foldable material illustrated to include a top panel having a first edge and a second edge of the top panel. A top panel vertex reference is defined between the first edge and the second edge of the top panel. A first top panel semicircular scored fold line scored into in the top panel of the foldable material about the top panel vertex reference and extending from the first edge to the second edge of the top panel. With reference to FIGS. 5A and 5B the line drawings illustrating the fifth embodiment show the foldable decorative structure where the semicircular scored fold line in the top panel is offset and the continuous shape defining line is not concentric. A second top panel semicircular scored fold line in the top panel about said first top panel semicircular scored fold line extends from the first edge to the second edge of the top panel. When folded into its closed position, a top cone is defined between the top panel vertex reference and the first top panel semicircular scored fold line with the first edge likewise abutting the second edge of the top panel.

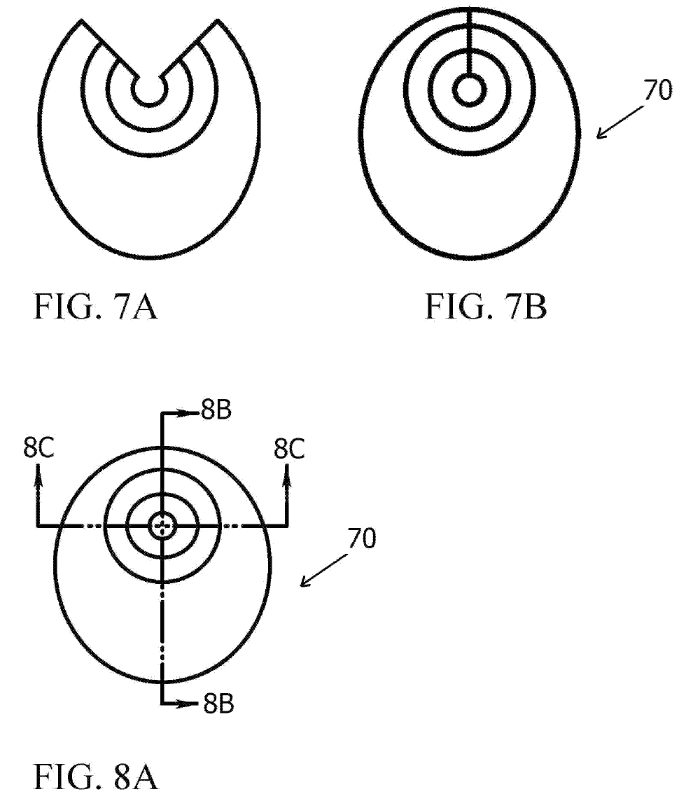

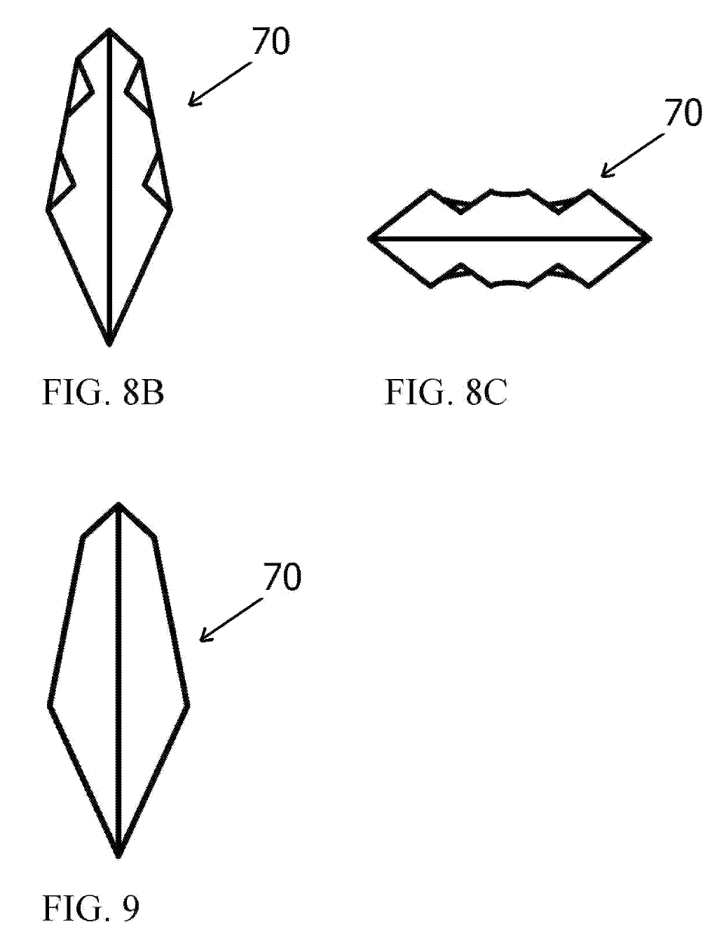

The decorative structures as described include a lamp within an interior region defined between the top cone and the bottom cone for receiving the lamp therein. The decorative structure of FIGS. 7A & 7B further illustrate the top cone and the bottom cone disposed in a position off center, as opposed to being centered as shown in the other embodiments, within the structure of the top panel and the opposing bottom panel with the first edge abutting the second edge of the top panel and the first edge abutting the second edge of the bottom panel which closes the structure of said top panel and said opposing bottom panel.

The paper lights of the present described embodiments are designed with the intention of providing accessible and decorative light shades, to be used alternately or additionally without a light source as dormitory, retail space, and home décor. This paper light is manufactured and shipped flat, reducing assembly tasks and shipping carton size. The paper light is packaged fully assembled, flat, and the consumer opens it out to a dimensional shade. This opening requires the use and manipulation of straight and/or curved scored lines, which when manipulated created a dimensional shade with high structural integrity. Unique features that distinguish Applicant's paper light from the other lights are that the shape can be held and locked through the consumer's manipulation of gussets, which when manually pushed in create dimension, structural integrity, define the perimeter peaks, points or petals, and hold the exterior shape. This creates an inner dimension that allows the shade to accommodate a standard or compact fluorescent bulb, along with a cage that encompasses the bulb for safety and to suspend the shade away from the bulb.

This gusset feature and how it is executed, allows this shade to take on structure, strength, and integrity. It provides the flexibility of shifting from a flat paper light to a 3-Dimensional paper light, allowing for cost effective manufacture and shipping. This feature also aids the shade to return to its original flat configuration. The curved and flat scores, when manipulated and then locked through agency of the gussets, create additional structural integrity as well as offer decorative features. In the described embodiments the scores and gussets create a star or flower shape, which can then be tied or fastened around a lamp cord, base, string, or used without any hanging or stationary support.

This shade can be used with structural integrity provided solely by the scoring and tie closure (note: this closure can be affected though other means than tying such as affixed tabs etc.) The gussets provide additional structure, design elements, and the locking function, which ensures shape, strength, and integrity. This shade has the additional feature, decorative and functional, of cut shapes which, when the shade is in it's dimensional form, create decorative light patterns and allow for the dissipation of heat. These cuts and perforations, as well as the number and design of points, petals, and scored structures, while maintaining a structural focus, change to provide a wealth of visually distinct designs.

The described decorative structure foldable light shades can be manufactured using a range of materials, paper, plastic, card, or fabric, using the structure provided, and can be printed, silk-screened, beaded, embroidered, or otherwise decorated. The design execution allows for the use of multiple colors and shadow play treatments. This paper light may also have additional decorative paper elements hanging from it or fringing it. This paper light is viable in a range of scales, from string lighting to large custom or feature lighting or décor, and may feature singly or in groupings.

The description of the assembly and related features and aspects proceeds by way of illustration, with FIG. 11 the panels as formed together are removed from a flat package. The shade has a hole (not a “necessary” component) in the center and around the central star or petaled shape are triangular “gussets. As illustrated in FIG. 12, one's thumb is placed in each center hole, vertex references, front and back, to grasp the center of the shade. Place fingers on the outside of the shade, fanned out, in the crease or score closest to the center and push in. The open edges of the shade (with attached strings) will come closer together as the shade takes on dimension and structure.

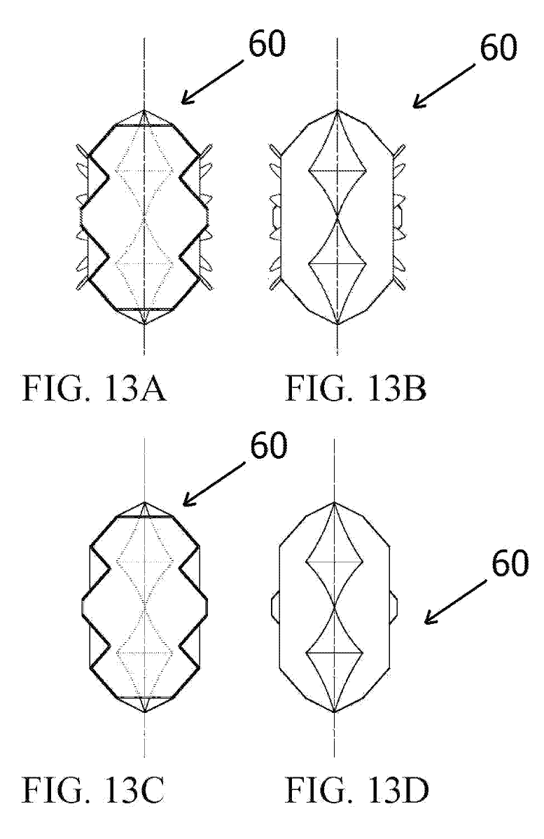

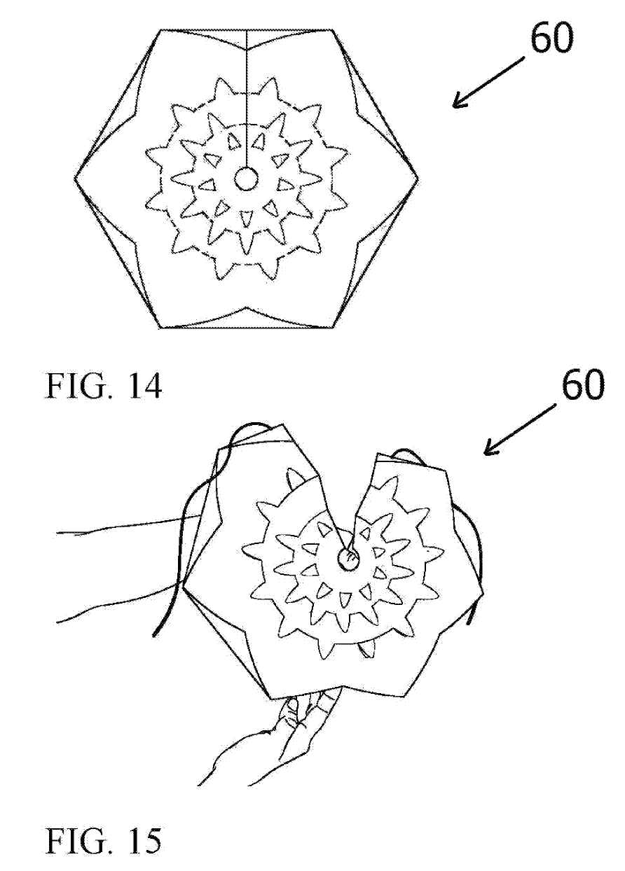

With reference to FIGS. 13A-13D, side sections are illustrated with details in FIGS. 13A and 13B, but may also be provided without details as illustrated in FIGS. 13C and 13D. Herein the center hole pierces front and back, and the folds that provide structure. In FIG. 14 a Front View Assembly is illustrated with the Gussets Out. Tie the strings together around a light cord or lamp base, or alternately as a décor item with or without a structure, e.g., with affixed tabs or other locking means. Bringing the closures together will bring the edges together and substantiate the structure. In this configuration the structure is hexagon shaped (or alternately 5, 7, 8, etc. sided . . . ) and the petals are distinguished only by use of distinct material or color. Referring to FIG. 15, while holding shade, with one hand outside or alternately inside the shade for support, push “gusset” in towards center until it snaps into position, creating a point or petal shape. This feature completes the dimension and locks the form's structure, creating stability and uniqueness of design and function.

From the foregoing, it can be seen that there have been provided features for lighting structure assembly methods and apparatus. While particular embodiments of the present invention have been shown and described, it will be obvious to those skilled in the art that changes and modifications may be made without departing from the invention in its broader aspects. Therefore, the aim is to cover all such changes and modifications as fall within the true spirit and scope of the invention. The matter set forth in the foregoing description and accompanying drawings is offered by way of illustration only and not as a limitation. The actual scope of the invention is intended to be defined by subsequent claims when viewed in their proper perspective based on the prior art.

What is claimed is:

1. A decorative structure comprising:
foldable material including a top panel having a first edge and a second edge of the top panel, and an opposing bottom panel having a first edge and a second edge of the bottom panel;
a top panel vertex reference defined between the first edge and the second edge of the top panel;
a bottom panel vertex reference defined between the first edge and the second edge of the bottom panel;
a top panel semicircular scored fold line in the top panel of the foldable material about the top panel vertex reference and extending from the first edge to the second edge of the top panel;
a bottom panel semicircular scored fold line in the bottom panel of the foldable material about the bottom panel vertex reference and extending from the first edge to the second edge of the bottom panel, said bottom panel semicircular scored fold line positioned to oppose said top panel semicircular scored fold line in the top panel of the foldable material;
a top panel continuous shape defining line in the top panel of the foldable material about said top panel semicircular scored fold line and extending from the first edge to the second edge of the top panel;
a bottom panel continuous shape defining line in the bottom panel of the foldable material about said bottom panel semicircular scored fold line and extending from the first edge to the second edge of the bottom panel, said bottom panel continuous shape defining line positioned to oppose said top panel continuous shape defining line in the top panel of the foldable material;
a top cone defined between the top panel vertex reference and the top panel semicircular scored fold line with the first edge abutting the second edge of the top panel; and
a bottom cone defined between the bottom panel vertex reference and the bottom panel semicircular scored fold line with the first edge abutting the second edge of the bottom panel.

2. The decorative structure of claim 1, comprising a lamp and an interior region defined between the top cone and the bottom cone for receiving the lamp therein, where the first edge abutting the second edge of the top panel and the first edge abutting the second edge of the bottom panel closes the structure of said top panel and said opposing bottom panel.

3. The decorative structure of claim 2, wherein the top cone and the bottom cone are disposed in a position off center within the structure of said top panel and said opposing bottom panel with the first edge abutting the second edge of the top panel and the first edge abutting the second edge of the bottom panel which closes the structure of said top panel and said opposing bottom panel.

4. The decorative structure of claim 1, wherein said foldable material includes a first end and a second end with the first end comprising said top panel and the second end comprising said bottom panel being foldable to oppose the top panel, said bottom panel vertex reference positioned to oppose said top panel vertex reference in the top panel thereof.

5. The decorative structure of claim 4, wherein said foldable material includes said top panel and said bottom panel integral with said top panel of the foldable material.

6. The decorative structure of claim 1, wherein said foldable material comprises a first foldable material portion and a second foldable material portion, said first foldable material portion comprising said top panel and said second foldable material portion comprising said bottom panel separate from said top panel.

7. The decorative structure of claim 1, wherein the first edge of the top panel and the second edge of the top panel are disposed on the foldable material with the first edge of the top panel facing and the second edge of the top panel at an angle relative to said first edge and said second edge of the top panel, and wherein the first edge of the bottom panel and the second edge of the bottom panel are disposed on the foldable material with the first edge of the bottom panel facing and the second edge of the bottom panel at an angle relative to said first edge and said second edge of the bottom panel.

8. The decorative structure of claim 7, wherein the first edge of the top panel and the second edge of the top panel are disposed on the foldable material with the first edge of the top panel facing and the second edge of the top panel at substantially a 90 degree angle, and wherein the first edge of the bottom panel and the second edge of the bottom panel are disposed on the foldable material with the first edge of the bottom panel facing and the second edge of the bottom panel at substantially a 90 degree angle.

9. The decorative structure of claim 1, comprising a plurality of gusset design elements at the periphery of the top panel and the bottom panel disposed on the foldable material for structural locking supporting shape, strength and integrity of the decorative structure.

10. The decorative structure of claim 1, comprising a plurality of cut shaped design elements disposed on the top panel or the bottom panel to create decorative light patterns and allow for the dissipation of heat, said plurality of cut shaped design elements comprising one or more cuts, perforations, petals, or scored elements in said foldable material.

11. A decorative structure comprising:
foldable material including a top panel having a first edge and a second edge of the top panel, and an opposing bottom panel having a first edge and a second edge of the bottom panel, wherein said foldable material comprises a first foldable material portion and a second foldable material portion, said first foldable material portion comprising said top panel and said second foldable material portion comprising said bottom panel separate from said top panel;
a top panel vertex reference defined between the first edge and the second edge of the top panel;
a bottom panel vertex reference defined between the first edge and the second edge of the bottom panel;
a top panel semicircular scored fold line in the top panel of the foldable material about the top panel vertex reference and extending from the first edge to the second edge of the top panel;
a bottom panel semicircular scored fold line in the bottom panel of the foldable material about the bottom panel vertex reference and extending from the first edge to the second edge of the bottom panel, said bottom panel semicircular scored fold line positioned to oppose said top panel semicircular scored fold line in the top panel of the foldable material;
a top panel continuous shape defining line in the top panel of the foldable material about said top panel semicircular scored fold line and extending from the first edge to the second edge of the top panel;
a bottom panel continuous shape defining line in the bottom panel of the foldable material about said bottom panel semicircular scored fold line and extending from the first edge to the second edge of the bottom panel, said bottom panel continuous shape defining line positioned to oppose said top panel continuous shape defining line in the top panel of the foldable material;
a top cone defined between the top panel vertex reference and the top panel semicircular scored fold line with the first edge abutting the second edge of the top panel;
a bottom cone defined between the bottom panel vertex reference and the bottom panel semicircular scored fold line with the first edge abutting the second edge of the bottom panel;
an interior region defined between the top cone and the bottom cone for receiving an object therein, where the first edge abutting the second edge of the top panel and the first edge abutting the second edge of the bottom panel closes the structure of said top panel and said opposing bottom panel to surround the object therein; and
closure means where the first edge abuts the second edge of the top panel and the first edge abutting the second edge of the bottom panel for closing the structure of the top panel and the opposing bottom panel.

12. The decorative structure of claim 11, comprising a plurality of gusset design elements at the periphery of the top panel and the bottom panel disposed on the foldable material for structural locking supporting shape, strength and integrity of the decorative structure.

13. The decorative structure of claim 11, wherein the first edge of the top panel and the second edge of the top panel are disposed on the foldable material with the first edge of the top panel facing and the second edge of the top panel at an angle relative to said first edge and said second edge of the top panel, and wherein the first edge of the bottom panel and the second edge of the bottom panel are disposed on the foldable material with the first edge of the bottom panel facing and the second edge of the bottom panel at an angle relative to said first edge and said second edge of the bottom panel.

14. A method for a foldable decoration assembly comprising:
providing a foldable material including a top panel having a first edge and a second edge of the top panel, and an opposing bottom panel having a first edge and a second edge of the bottom panel;
defining a top panel vertex reference between the first edge and the second edge of the top panel;
defining a bottom panel vertex reference between the first edge and the second edge of the bottom panel;
scoring a top panel semicircular scored fold line in the top panel of the foldable material about the top panel vertex reference and extending from the first edge to the second edge of the top panel;
scoring a bottom panel semicircular scored fold line in the bottom panel of the foldable material about the bottom panel vertex reference and extending from the first edge to the second edge of the bottom panel, said bottom panel semicircular scored fold line positioned to oppose said top panel semicircular scored fold line in the top panel of the foldable material;
scoring a top panel continuous shape defining line in the top panel of the foldable material about said top panel semicircular scored fold line and extending from the first edge to the second edge of the top panel;
scoring a bottom panel continuous shape defining line in the bottom panel of the foldable material about said bottom panel semicircular scored fold line and extending from the first edge to the second edge of the bottom panel, said bottom panel continuous shape defining line positioned to oppose said top panel continuous shape defining line in the top panel of the foldable material;
defining a top cone between the top panel vertex reference and the top panel semicircular scored fold line with the first edge abutting the second edge of the top panel; and
defining a bottom cone between the bottom panel vertex reference and the bottom panel semicircular scored fold line with the first edge abutting the second edge of the bottom panel.

15. The method of claim 14, comprising providing a lamp in an interior region defined between the top cone and the bottom cone for receiving the lamp therein, where the first edge abutting the second edge of the top panel and the first edge abutting the second edge of the bottom panel closes the structure of said top panel and said opposing bottom panel.

16. The method of claim 15, comprising providing closure means where the first edge abuts the second edge of the top panel and the first edge abutting the second edge of the bottom panel for closing the structure of the top panel and the opposing bottom panel.

17. The method of claim 15, comprising positioning the top cone and the bottom cone off center within the structure of said top panel and said opposing bottom panel with the first edge abutting the second edge of the top panel and the first edge abutting the second edge of the bottom panel which closes the structure of said top panel and said opposing bottom panel.

18. The method of claim 14, wherein the step of providing the foldable material further comprises providing a first foldable material portion and providing a second foldable material portion, said first foldable material portion comprising said top panel and said second foldable material portion comprising said bottom panel separate from said top panel.

19. The method of claim 14, comprising providing a plurality of gusset design elements at the periphery of the top panel and the bottom panel disposed on the foldable material for structural locking supporting shape, strength and integrity of the decorative structure.

20. The method of claim 14, comprising providing a plurality of cut shaped design elements disposed on the top panel or the bottom panel to create decorative light patterns and allow for the dissipation of heat, said plurality of cut shaped design elements comprising one or more cuts, perforations, petals, or scored elements in said foldable material.
